(19) United States
(12) Patent Application Publication
(10) Pub. No.: US 2007/0062826 A1
(43) Pub. Date: Mar. 22, 2007

(54) Structure of cap having storage space

(76) Inventors: Jeong-Min Lee, Seoul (KR); Seong Jae Lee, Seoul (KR)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 10/592,025

(22) PCT Filed: Feb. 16, 2005
(86) PCT No.: PCT/KR05/00416

§ 371 Date: Sep. 7, 2006

(30) Foreign Application Priority Data
Feb. 19, 2004 (KR) 10-2004-0012050
Feb. 19, 2004 (KR) 10-2004-001-2051
Feb. 19, 2004 (KR) 10-20040012053
Feb. 19, 2004 (KR) 10-2004-0012052
Feb. 19, 2004 (KR) 10-2004-0012049
Feb. 20, 2004 (KR) 10-2004-0012430
Mar. 8, 2004 (KR) 10-2004-0016674
Mar. 8, 2004 (KR) 10-2004-0016676
Mar. 8, 2004 (KR) 10-2004-=0016675

(51) Int. Cl. B65D 25/08; B67D 5/06; B67D 5/00

(52) U.S. Cl. 206/222; 222/536; 222/83; 222/534; 222/541.9; 206/219

(57) ABSTRACT

A cap with a storage space for containing a secondary material includes a storage portion having a storage space and provided with a seal plate formed on a lower end of the storage space, an outer cap foldably formed on the storage portion and coupled to a spouting portion, a spouting member inserted in the spouting portion, and an operational member for breaking the seal plate when the spouting member is operation.

### TECHNICAL FIELD

The present invention relates to a cap having a storage space storing different material that can be mixed with main material contained in a container.

### BACKGROUND ART

In a variety of industrial field, it is sometimes necessary to mixed two or more different materials with each other to prepare a mixture, prior to using the mixture.

For example, when it comes to beverage industrial filed, users wishes to add a variety of flavors or vitamin to the water. To this end, the user purchases the flavor or vitamin and the separated bottle water and mixes the flavor or the vitamin with the bottle water.

### SUMMARY OF THE INVENTION

Therefore, the present invention has been made in an effort to solve the above-described problems of the conventional art.

It is an object of the present invention to provide a cap with a storage chamber for a secondary material that will be mixed with a primary material contained in a container associated with the cap by simply opening the cap.

It is another object of the present invention to provide a product employing such a cap with a storage chamber for a secondary material.

To achieve the above objects, the present invention provides a cap with a storage space for containing a secondary material includes a storage portion having a storage space and provided with a seal plate formed on a lower end of the storage space, an outer cap foldably formed on the storage portion and coupled to a spouting portion, a spouting member inserted in the spouting portion, and an operational member for breaking the seal plate when the spouting member is operation.

### BRIEF DESCRIPTION OF THE DRAWINGS

FIG. 1 is a perspective view of a cap with a storage space according to a first embodiment of the present invention;

FIG. 2 is a sectional view of FIG. 1;

FIG. 3 is a perspective view illustrating a use of FIG. 1;

FIG. 4 is a sectional view of a cap according to a second embodiment of the present invention;

FIG. 5 is a sectional view of a cap according to a third embodiment of the present invention;

FIG. 6 is a view illustrating an operational state of a cap depicted in FIG. 5;

FIG. 7 is a perspective view of a modified example of a cap;

FIG. 8 through 10 are views of a cap according to a fourth embodiment of the present invention;

FIG. 11 through 13 are view of a cap according to a fifth embodiment of the present invention;

FIG. 14 is a sectional view of a cap according to a sixth embodiment of the present invention;

FIG. 15 is a partial broken side view of a cap structure of the present invention;

FIG. 16 is a view illustrating an operational state of a cap of the present invention;

FIGS. 17 through 18 are views of a cap according to an eighth embodiment of the present invention;

FIGS. 19 through 20 are views of a cap according to a ninth embodiment of the present invention;

FIGS. 21 through 22 are views of a cap according to a tenth embodiment of the present invention;

FIGS. 23 through 15 are views of a cap according to an eleventh embodiment of the present invention; and

FIGS. 26 through 27 are views of a cap according to a twelfth embodiment of the present invention;

### BEST MODE FOR CARRYING OUT THE INVENTION

Preferred embodiments of the present invention will be described more in detail hereinafter in conjunction with the accompanying drawings. Wherever possible, the same reference numerals will be used throughout the drawings to refer to the same or like parts.

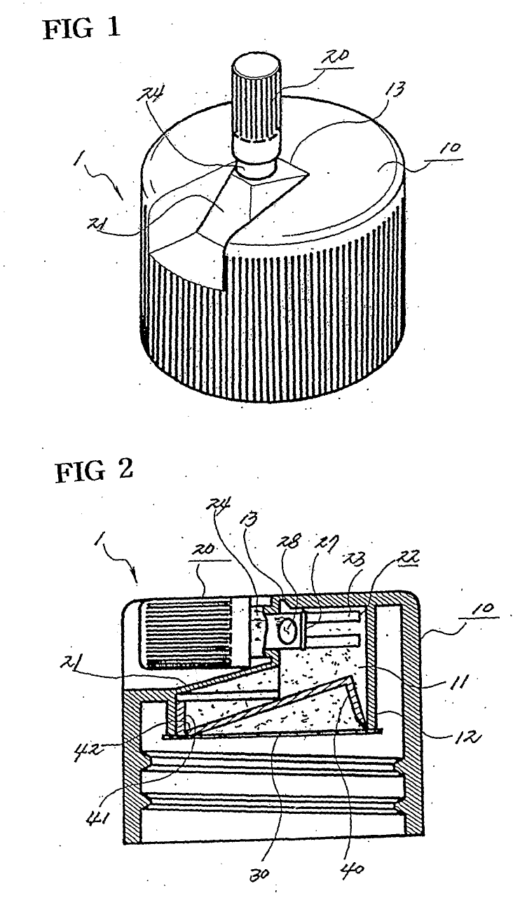

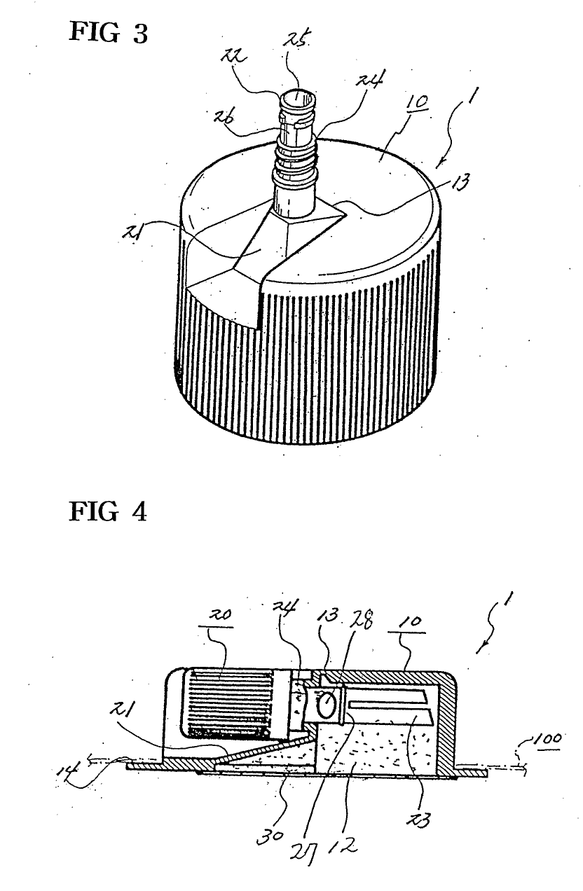

FIGS. 1 through 3 shows a cap according to a first embodiment of the present invention.

A cap 1 is screw-coupled to a container.

The cap 1 includes a cap main body 10 having a storage portion 12 defining a storage space 11 and an outer cap 20 coupled to the cap main body 10.

The cap 1 includes a seal plate 30 and an operation member 40 that is designed to break the seal plate according to the operation of the outer cap 20. The operational member 40 is located inside the storage portion 12.

The seal plate 30 is preferably formed of synthetic resin or aluminum, being attached on a lower end of the storage portion 12.

The cap main body 10 is provided with a folding portion 21 with a folding line 13. A spouting portion 24 is formed on an outer surface of the folding portion 21 and coupled to the outer cap 20. A spouting member 22 is inserted in the spouting portion 24.

The spouting member 22 is provided with an operational projection 23 extending downward to break the seal plate 30. A hook step 27 is formed on the spouting portion 24 to prevent the spouting member 22 from removing. A spouting hole 28 is provided to exhaust a mixture.

The spouting member 22 is provided with a spouting passage 25 and an air introduction portion 26 in a longitudinal direction.

The operational member 40 is provided with fixing portion 41 fixed inside the storage portion 12 and connected to the fixing portion 41 by a connection portion 42.

In the above-described embodiment, in a state when different material is stored in the storage portion 12, the seal plate 30 is attached and the cap main body 10 coupled to the outer cap 20 is fixed on the container.

In this state, the spouting portion 24 and the outer cap 20 are disposed on a horizontal plan as shown in FIG. 2.

At this point, as shown in FIG. 1, when the spouting portion 24 and the outer cap 20 are pivoted to a vertical position, the folding portion 21 is moved outward by the folding line 13 and the operational projection 23 formed on the spouting portion 22 pivots to allow the operational member 40 to pivot and break the seal plate 30.

Therefore, the different material stored in the storage portion 12 is dropt into the container to mix with main material contained in the container.

In this state, the outer cap 20 is separated and the mixture can be spouted through the spouting passage 25 through the spouting hole 28 of the spouting member 22.

Since the spouting member 22 is vertically movable, the user can be more easily drink the mixture. Furthermore, since the air introduction portion 26 is formed on the spouting member 22, the mixture can be effectively discharged.

FIG. 4 shows a second embodiment of the present invention.

A cap main body 10 is provided with a storage space 11. A seal plate 30 is attached on a lower end of the storage space 11. A pouch container 100 is attached on the cap main body.

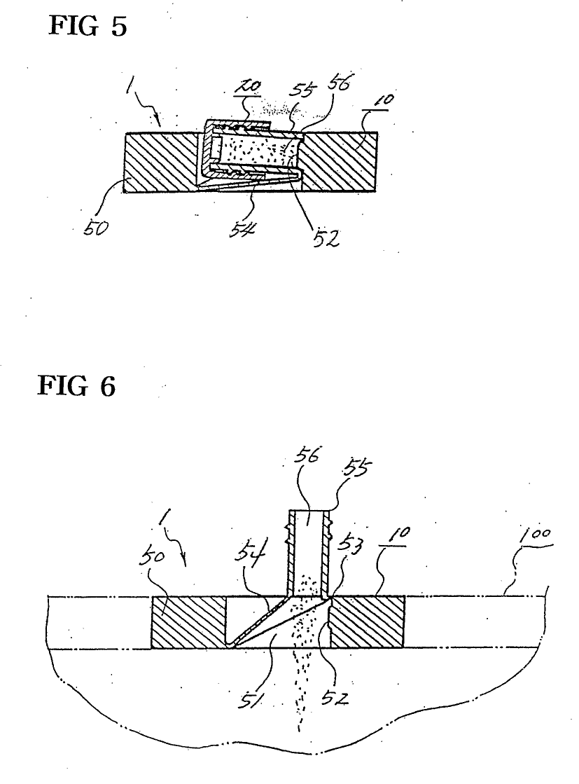

FIGS. 5 and 6 shows a third embodiment of the present invention.

In this embodiment, a seal step is formed in a space 51.

A folding portion is integrally formed in the space 51 with a folding line 53. A spouting portion 55 is formed in the folding portion and an outer cap 200 is coupled to the spouting portion 55.

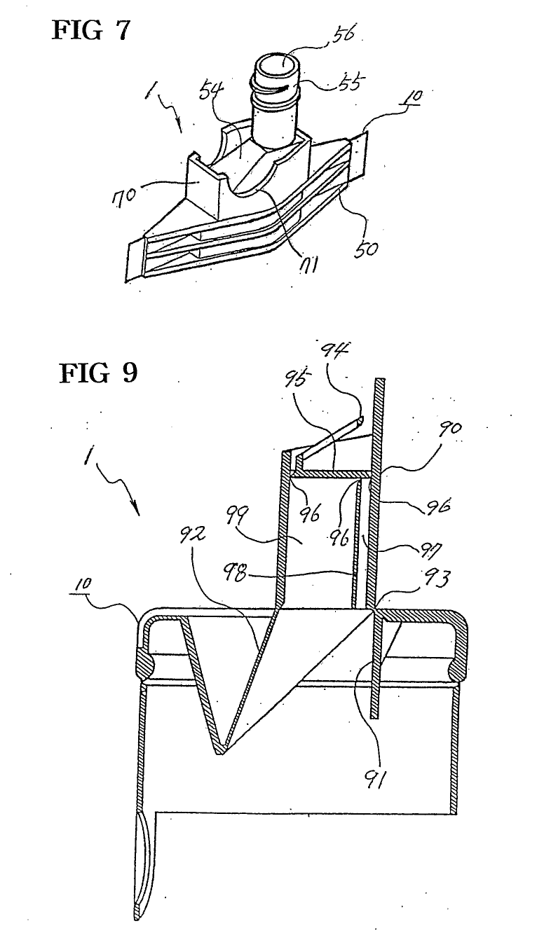

Referring to FIG. 7, a protecting member 70 is formed on an opened top of the cap main body 10, being provided with a concave portion 71.

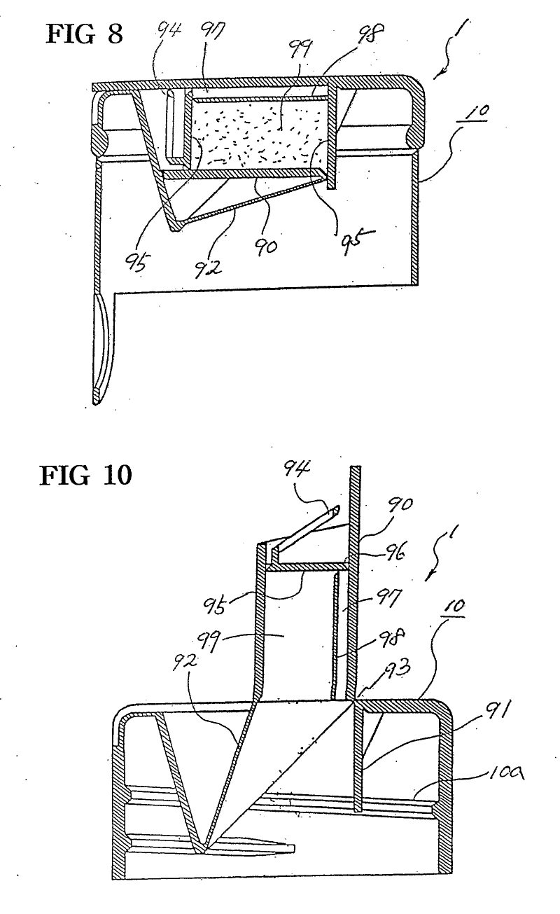

FIGS. 8 through 10 shows a fourth embodiment of the present invention.

A cap 1 includes a cap main body 10 and a spouting portion 90 formed on the cap main body.

A cutting plate 95 with a pulling ring 94 is formed on the spouting portion 92.

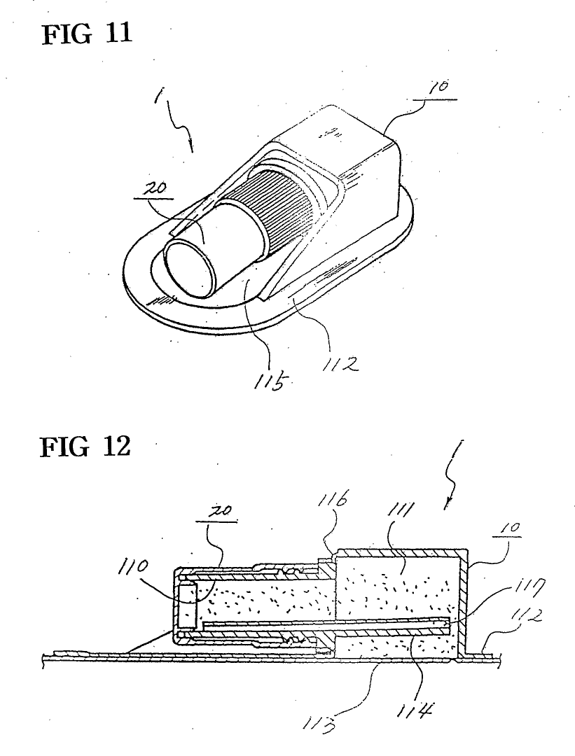

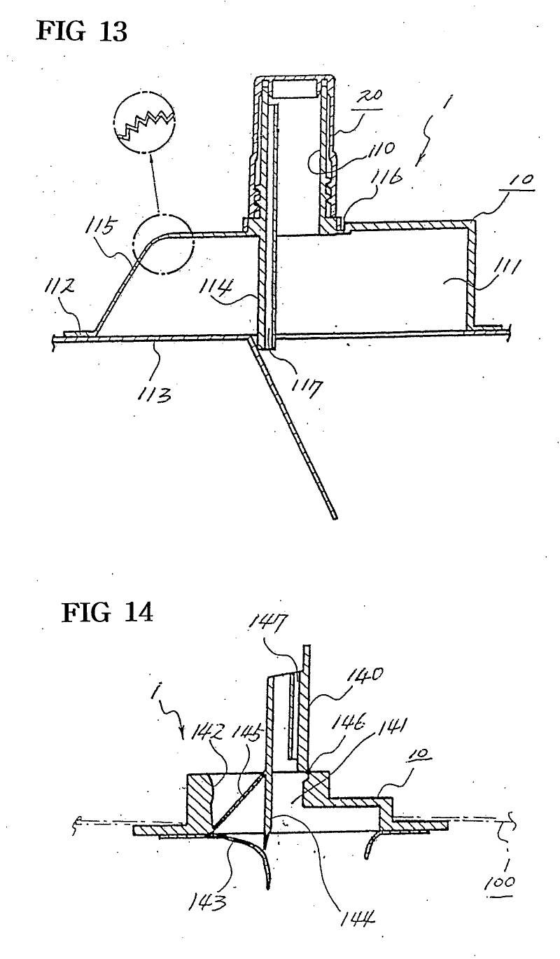

FIGS. 11 through 13 are views of a cap according to a fifth embodiment of the present invention.

This embodiment is similar to the first embodiment.

FIG. 14 is a sixth embodiment of the present invention.

A withdrawal wing 148 is formed on the spouting portion 140. In this embodiment, there is no need of an outer cap for opening the spouting portion 140.

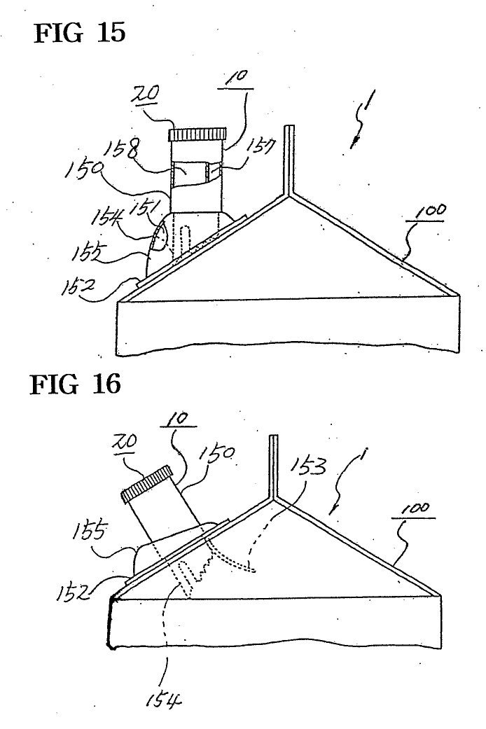

FIGS. 15 through 16 shows a seventh embodiment of the present invention.

In this embodiment, the container is formed of a carton bag.

An air introduction portion 157 is formed on the spouting portion 150.

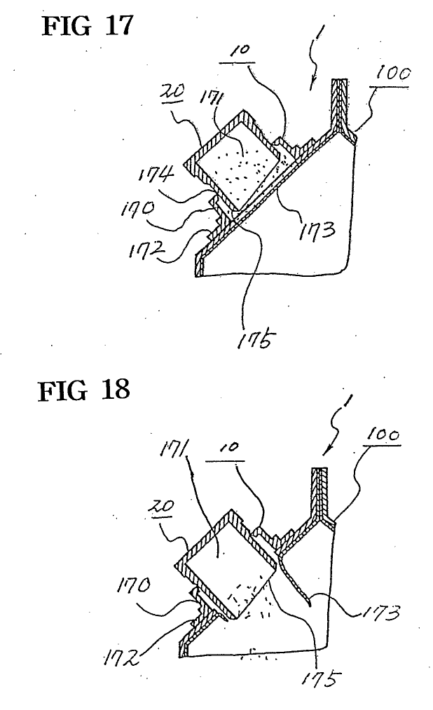

FIGS. 17 through 18 shows an eighth embodiment similar to the first embodiment.

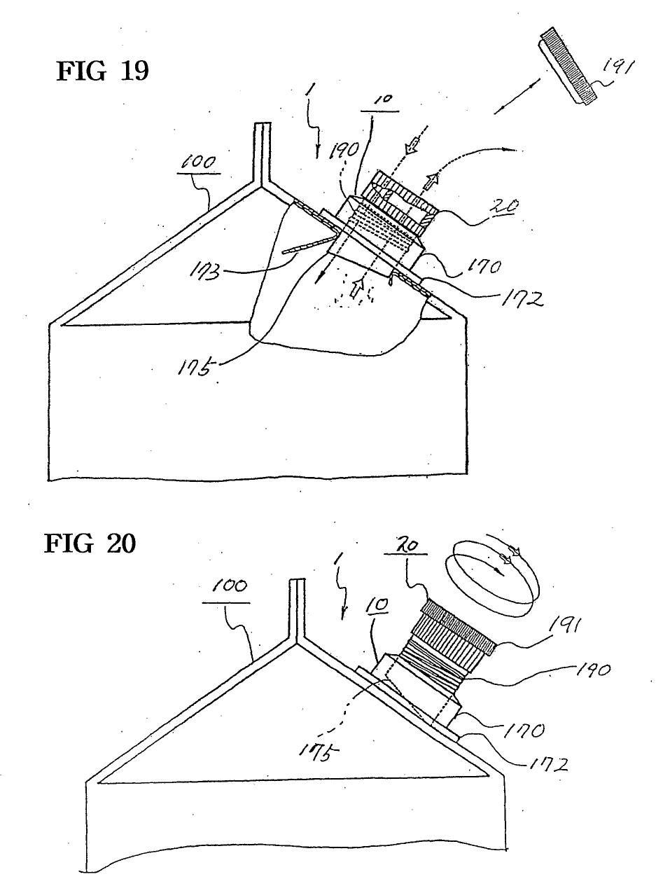

FIGS. 19 through 20 shows a ninth embodiment of the present invention similar to the eighth embodiment.

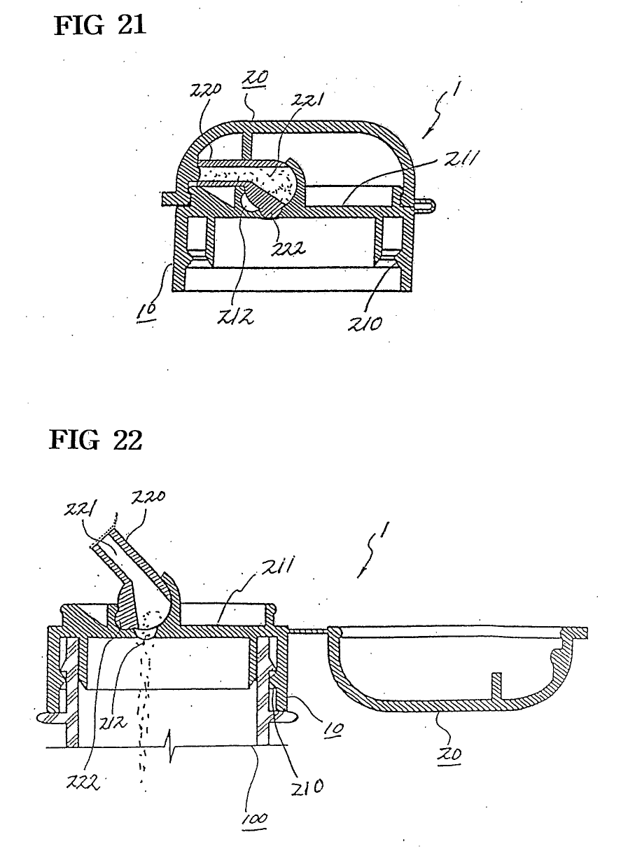

FIGS. 21 through 22 show a tenth embodiment of the present invention. A barrier 211 is formed on the cap main body.

A storage member 220 stores different material and is designed to be pivoted to exhaust the different material. After exhausting the different material, it functions as a spouting member for exhausting the mixture.

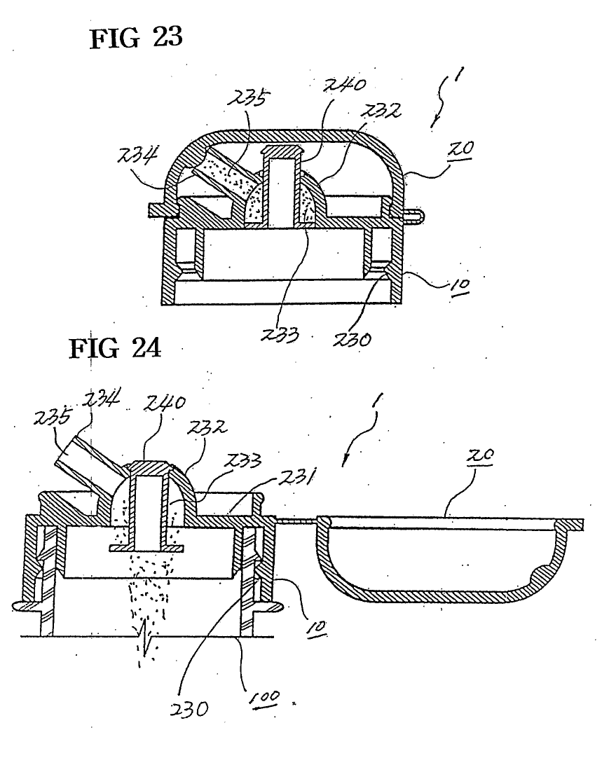

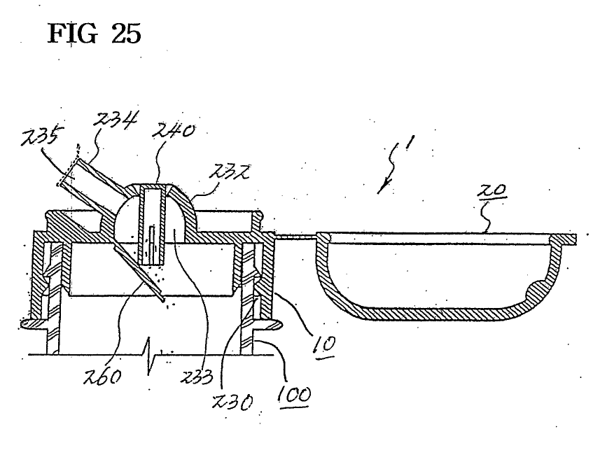

FIGS. 23 through 25 shows an eleventh embodiment of the present invention.

A spouting portion is formed on a storage portion 232. An operational member 240 is coupled to the storage space 233.

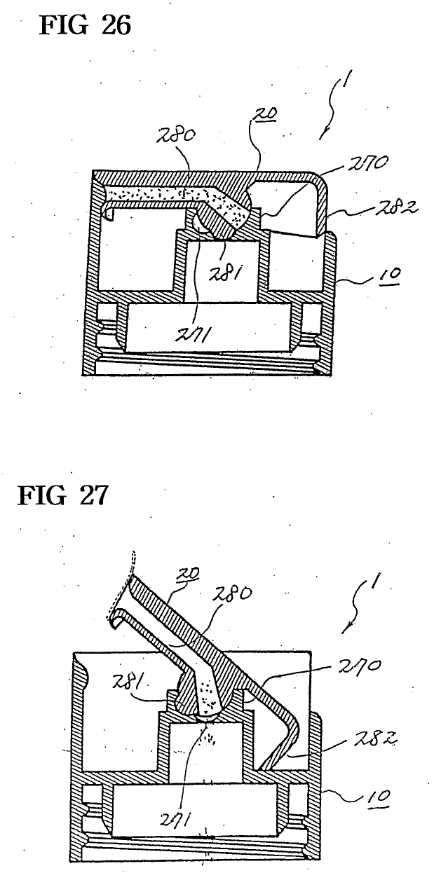

FIGS. 26 through 27 show a twelfth embodiment of the present invention.

An outer cap is pivotally coupled to a cap main body. The outer cap 20 is provided with a storage space 280. A stopper 282 is formed on the outer cap, which contacts a coupling portion.

The outer cap is rotated by a predetermined angle by the stopper 282 to communicate with a seal groove 271 of the storage space 280.

When the outer cap 20 is pivoted to a horizontal plate, the seal hole 271 is closed again.

### INDUSTRIAL APPLICABILITY

As described above, the present invention is directed to a pouch container with a spout assembly, in which the spout assembly can be hygienically protected. The present invention is further directed to a method for mass production of such a pouch container.

1. a cap with a storage space for containing a secondary material, comprising:
a storage portion having a storage space and provided with a seal plate formed on a lower end of the storage space;
an outer cap foldably formed on the storage portion and coupled to a spouting portion;
a spouting member inserted in the spouting portion; and
an operational member for breaking the seal plate when the spouting member is operation.

2. The cap of claim 1, wherein the spouting portion is formed on a folding portion with a folding line.

3. The cap of claim 1, wherein the spouting member is provided with an operational projection applying force to the operational member.

4. The cap of claim 1, wherein the spouting member is provided with an air introduction portion.

5. The cap of claim 1, wherein the operational member is fixed on an inner surface of the storage portion to move in a pivotal motion.

6. A cap with a storage space for containing a secondary material, comprising:
a space portion having a storage space and provided with a seal plate formed on a lower end of the storage space;
an spouting portion foldably formed in the storage portion; and
an outer cap detachably formed on the spouting portion.

7. The cap of claim 6, wherein the space portion is provided with a seal step to which the spouting portion closely contacts.

8. The cap of claim 6, wherein the spouting portion and the folding portion are formed in a protecting member having a concave portion, which is formed on an upper portion of the cap main body.

9. A cap comprising:
a cap main body coupled on a container and provided with a seal plate therein;
a spouting portion in which different material is stored, the spouting portion formed on an upper-inner portion of the cap main body and provided with a folding portion to pivot at a predetermined angle; and
a cutting plate formed on an upper-inner portion of the spouting portion.

10. The cap of claim 9, wherein the spouting portion is provided with an air introduction portion.

11. The cap of claim 9, wherein the cutting plate is provided with a pulling ring.

12. The cap of claim 9, wherein the cam main body is screw-coupled to the container.

13. A cap comprising:
a cap main body having a storage space defining portion in which different material is stored, a sealing plate attached on a lower portion of the storage space defining portion, and a spouting portion pivotally at a predetermined angle and formed on a folding portion; and
an outer cap coupled to the spouting portion.

14. The cap of claim 14, wherein the spouting portion is provided with an operational projection breaking the sealing plate as it pivots.

15. The cap of claim 13, wherein the spouting portion is provided with an air introduction portion.

16. A cap comprising:
a storage portion in which different material is stored, a sealing plate attached on a lower portion of the storage portion, and a spouting portion formed on a folding portion to pivot at a predetermined angle.

17. The cap of claim 16, wherein the spouting portion is provided with an air introduction portion.

18. The cap of claim 16, wherein the spouting portion is provided with an operational projection breaking the sealing plate.

19. The cap of claim 16, wherein the cap main body is attached on a carton pack.

20. The cap of claim 16, wherein the spouting portion has an extreme end to which the outer cap is coupled.

21. A cap comprising:
a cap main body having a storage portion in which different material is stored, a spouting portion through which a mixture is discharged and a sealing plate attached on a lower portion of the storage portion; and
an outer cap having an operational projection breaking the sealing plate.

22. The cap of claim 21, wherein the outer cap is screw-coupled in the spouting portion.

23. The cap of claim 21, wherein the outer cap is coupled to a sub-cap.

24. The cap of claim 23, wherein the outer cap is provided with an air introduction portion.

25. A cap comprising:
a cap main body having a fixing portion fixed on a container and a barrier having a seal groove;
an outer cap coupled to the cam main body; and
a storage portion coupled to the seal groove to store different material.

26. The cap of claim 25, wherein the storage portion is provided with a seal projection selectively opening the seal groove.

27. A cap comprising:
a storage portion in which different material is stored;
a cap main body having a spouting portion formed on the storage portion;
an operation member coupled to the storage portion to selectively open the storage portion; and
an outer cap coupled to the cap main body.

28. The cap of claim 27, wherein the operational member is designed to seal a lower end of the storage portion.

29. The cap of claim 27, wherein a sealing plate is integrally formed with the cap main body, the sealing plate being designed to be broken by the operational member.

30. A cap comprising:
a cap main body provided with a coupling portion having a seal groove; and
an outer cap coupled to the coupling portion to store different material.

31. The cap of claim 30, wherein the outer cap is provided with a seal projection selectively opening the seal groove.

32. The cap of claim 30, wherein the outer cap is provided with a stopper for hooking on the coupling portion to communicate with the storage portion with the seal groove.
